(19) United States
(12) Patent Application Publication
(10) Pub. No.: US 2026/0275239 A1
(43) Pub. Date: Sep. 17, 2026

(54) PHOSPHONATE-FREE LIQUID LAUNDRY DETERGENT COMPOSITION

(71) Applicant: Reckitt Benckiser (España), S.L., Barcelona, Granollers (ES)

(72) Inventors: Marcella BONESSO, Padua (IT); Giulia COLLEDAN, Venice (IT); Xavier CUADRAT, Granollers (ES); Remigio MUSCI, Venice (IT)

(21) Appl. No.: 19/471,957

(22) PCT Filed: Apr. 4, 2024
(86) PCT No.: PCT/EP2024/059230

§ 371 Date: Oct. 2, 2025

(30) Foreign Application Priority Data
Apr. 4, 2023 (GB) 2304995.0

(51) Int. Cl. C11D 1/94; C11D 3/04; C11D 3/20; C11D 3/33; C11D 3/386

(52) U.S. Cl. CPC C11D 1/94; C11D 3/046; C11D 3/201; C11D 3/2065; C11D 3/33; C11D 3/386; C11D 2111/12; C11D 2111/44

(57) ABSTRACT

A phosphonate and thickener free concentrated liquid laundry detergent composition comprising (a) from about 10% to about 25%, preferably between 12% to 24%, by weight of an anionic surfactant; (b) from about 1% to about 5%, preferably between 2% to 3%, by weight of an amphoteric surfactant; (c) from about 10% to about 25%, preferably between 12.5% to 23.5%, by weight of a non-ionic surfactant selected from the group consisting of ethoxylated alcohol C₁₂-C₁₆; (d) from about 10% to about 20%, preferably between 12.5% to 15%, by weight of at least one polyhydric alcohol; wherein the composition is free of any thickeners and has a viscosity less than 750 cP at a temperature of about 20° C. and methods of use thereof.

### TECHNICAL FIELD

This disclosure relates to phosphonate free liquid laundry detergent composition having viscosity less than 750 cP at temperatures ranging from 17.5 to 27.5° C. and methods for washing a garment and using said detergent composition.

### BACKGROUND INFORMATION

Laundry detergents are substances which can be added when one is washing fabrics to help get the fabrics cleaner. Liquid laundry detergents generally contain a blend of different types of surfactants along with additional ingredients such as builders, dispersants, chelants, thickeners, and bleaching agents. Surfactants reduce the surface tension of the water, allowing the water to penetrate the fabric rather than slide off its surface, so that it can more effectively remove the dirt from the clothing, and/or allow effective washing away.

Concentrated liquid laundry compositions have previously been described in the art. For example, U.S. Pat. No. 7,985,725 describes ultra-concentrated liquid laundry detergent. However, when adding tap water, the concentrated liquid detergent composition typically forms a visible precipitation of soaps, and the resulting viscosity of such compositions dramatically drop depending on the amount of tap water added. Such outcomes ultimately reduce efficacy of the detergents because contact time with the laundry material are reduced.

Even though, thickeners have been used in the art to address the viscosity issues associated with laundry detergents, the incorporation of thickeners typically lead to chemical and physical instability of the product, causing a shorter shelf life and increasing consumer complaints and perceptions of ineffective composition. For such reasons there is a need for providing more effective laundry detergent compositions.

### SUMMARY OF THE INVENTION

The present invention addresses the major technical challenge in achieving a detergent that maintains proper rheological properties, in particular viscosity, even after dilution with water.

In certain embodiments, the viscosity may increase despite dilution of the concentrated detergent composition in the water.

In the first aspect of the present invention, phosphonate free concentrated liquid detergent compositions are provided having a viscosity of less than 750 centipoise (cP) at temperatures ranging from 17.5 to 27.5° C., preferably in temperatures ranging between 20° C. to 25° C., and a shear rate of 4 s⁻¹, which when diluted with water undergo minor changes in its viscosity. Accordingly, the first aspect of the invention provides for a phosphonate free liquid detergent composition containing (a) from about 10% to about 25%; preferably between 12% to 24%, by weight of an anionic surfactant, (b) from about 1% to about 5%, preferably between 2% to 3% by weight of an amphoteric surfactant; (c) from about 10% to about 25%; preferably between 12.5% to 23.5%, by weight of one or more non-ionic surfactants selected from the group consisting of non-ionic surfactant selected from the group of C₁₂-C₁₆ ethoxylated alcohols, (d) from about 5% to about 20%; preferably between 12.5% to 15%, by weight of at least one polyhydric alcohol; wherein the composition is substantially free of any thickeners, and has a viscosity less than 750 cP at a temperature of about 20° C. and a shear rate of 4 s⁻¹, and the weight ratio of the total anionic surfactant to one or more non-ionic surfactants is 0.75-2.0:0.75-2.5.

In some embodiments, the viscosity of the compositions according to the present invention is less than 500 (cP) at temperatures ranging from 17.5 to 27.5° C., preferably in temperatures ranging between 20° C. to 25° C., and a shear rate of 4 s⁻¹, which when diluted with water undergo minor changes in its viscosity.

In some embodiments, the amphoteric surfactant is present in amounts between 2.5% to 2.8% by weight of the composition.

In some embodiments according to the first aspect of the invention, the weight ratio of the total anionic surfactants to one or more non-ionic surfactants is 1.0-2.0:1.0-1.5. In preferred embodiments, the total anionic surfactant:non-ionic surfactant is 1:1; 1.5:1.0; 2:1; 1:2; or 1:1.5. In some embodiments, the weight ratio of the total anionic surfactant(s) to the one or more non-ionic surfactant(s) to polyhydric alcohol may be about of 1:1: <0.8-1 respectively.

In some embodiments, the composition further includes (e) from about 0.5 to about 7.5%, preferably between 1% to 5%, by weight of an alkali salt; and (f) up to about 45% by weight of water, preferably between 5% to 30% by weight of water. In some embodiments, the alkali salt is chloride salt, preferably sodium chloride.

In some embodiments, the composition according to the first aspect of the present invention has the viscosity of the compositions according to the present invention is less than 500 (cP), or 400 (cP) at temperatures ranging from 17.5 to 27.5° C., preferably in temperatures ranging between 20° C. to 25° C., and a shear rate of 4 s⁻¹, which when diluted with water undergo minor changes in its viscosity.

In some other embodiments, the composition according to the first aspect of the present invention has the viscosity ranges between 50 to 350 cP, or 100 to 250 cP, measured at a temperature of 20° C. and a shear rate of 4 s⁻¹.

In some embodiments, the anionic surfactant used in the liquid detergent composition of the present invention is a sulfonic acid, an alkali metal salt of C₁₀-C₁₆ alkyl benzene sulfonic acids, or preferably an alkali metal salt of linear C₁₀-C₁₃ alkyl benzene sulfonic acids. In some embodiments, the anionic surfactant is selected from the group consisting of alcohol sulfates and sulfonates, alcohol phosphates and phosphonates, alkyl benzene sulfonic acids, alkyl ester sulfates, alkyl diphenyl ether sulfonates, alkyl sulfates, alkyl ether sulfates, sulfate esters of an alkylphenoxy polyoxyethylene ethanol, alkyl monoglyceride sulfates, alkyl sulfonates, alkyl ether sulfates, alpha-olefin sulfonates, beta-alkoxy alkane sulfonates, alkyl ether sulfonates, ethoxylated alkyl sulfonates, alkylaryl sulfonates, alkylaryl sulfates, alkyl monoglyceride sulfonates, alkyl carboxylates, alkyl ether carboxylates, alkyl alkoxy carboxylates, sulfosuccinates, acyl glycerol sulfonates, fatty oleyl glycerol sulfates, alkyl phenol ethylene oxide ether sulfates, paraffin sulfonates, alkyl phosphates, isethionates, N-acyl taurates, alkyl succinamates and sulfosuccinates, alkylpolysaccharide sulfates, alkylpolyglucoside sulfates, alkyl polyethoxy carboxylates, and mixtures thereof; preferably, wherein the anionic surfactant is an alkyl benzene sulfonic acid, an alcohol sulfate, an alcohol sulfonate, alcohol phosphate, an alcohol phosphonate, a paraffin sulfonate, an alkyl phosphate, salts thereof, or any mixture thereof; and most preferably, the anionic surfactant is an alkali metal salts of C₁₀-C₁₆ alkyl benzene sulfonic acids, preferably C₁₁-C₁₃ alkyl benzene sulfonic acids.

In some embodiments, the amphoteric surfactant is selected from the group consisting of betaines, imidazolines, proprionates and mixtures thereof. In preferred embodiments, the amphoteric surfactant is a cocamidopropyl betaine.

In some embodiments, the one or more non-ionic surfactants are selected from the group consisting of C₁₂-C₁₆ ethoxylated alcohol having six, seven or eight degrees of ethoxylation degree, and preferably seven.

In some embodiments, the one or more non-ionic surfactants are selected from the group consisting of C₁₂-C₁₆ ethoxylated alcohol having six, seven or eight ethoxylation degree, the amphoteric surfactant is cocamidopropyl betaine, and the anionic surfactant is a C₁₀-C₁₃ alkyl benzene sulfonic acids.

In certain embodiments, the amount of the anionic surfactant in the composition is in the range of 16% to 22% by weight and the amount of the one or more non-ionic surfactants ranges between about 16% to 22% by weight of the composition.

In some embodiments, the polyhydric alcohol is selected from the group consisting of C₂-C₆ alcohols, containing from 2-6 hydroxyl groups; preferably monopropylene glycol, dipropylene glycol, butylene glycol, either alone or in any combinations thereof.

In some embodiments, the composition includes a chelating agent selected from the group consisting of MGDA, GLDA, EDTA, and any salts thereof or combinations thereof; preferably MGDA.

In other embodiments, the composition of the present invention further contains an enzyme selected from the group consisting of an amylase, a mannanase, a protease, a lipase, a cellulase, a pectin lyase, endocellulases, exocellulases or any combinations thereof.

In some embodiments, the alkali salt is sodium chloride. In some embodiments, the pH of the composition ranges between 7 to about 8.75, preferably between 8.2 to 8.6.

In some embodiments, the concentrated detergent composition according to the first aspect of the present invention contains: (a) a sulphonic acid as the anionic surfactant in amounts of about 16% to about 22% by weight; (b) cocamidopropyl betaine as the amphoteric surfactant in amounts of about 2% to about 3%; (c) a C₁₃-C₁₅ fatty alcohol having 7EO as the one or more non-ionic surfactants in amounts of about 16% to about 22% by weight; (d) monopropylenglycol as the polyhydric alcohol is in amounts of about 12.5% to 15%, by weight; and (e) sodium chloride as the alkali salt is in amounts of about 2% to 3% by weight. In some embodiments, the composition has the viscosity ranges between 50 to 450 cP at 20° C. and a shear rate of 4 s⁻¹, preferably 100 to 350 cP, more preferably 100 to 250 cP.

In second aspect of the present invention, diluted detergent compositions are described characterized in that when the concentrated detergent composition of the first aspect of the invention is diluted with a volume of water at a detergent to water ratio ranging between 1 to 5 part(s) detergent to up to 10 to 15 parts of water, the resulting diluted mixture having a higher viscosity despite dilution in the water respective to its precursor concentrated form, and preferably having a viscosity ranging between about 100 cP to about 500 cP, at a temperature of about 20° C. and a shear rate of 4 s−1, more preferably about 150 to about 475 cP, and most preferably 150 to 300 cP. In some embodiments, the viscosity may be in the ranges of 100 to 250 cP. In some embodiments, the concentrated composition according to the first aspect of the present invention is diluted with water at such ratios of concentrated detergent to water including 1:1, 1:2 or 1:3 respectively and yet maintains a viscosity after it is diluted in the range of 50 to 350 cP at a temperature of about 20° C. and a shear rate of 4 s−1.

In third aspect of the invention, method of cleaning fabrics in an automatic washing machine are described wherein the method comprising providing an effective amount of a concentrated phosphonate-free liquid laundry detergent composition according the first aspect of the present invention, diluting it with a volume of water in amount ranging between 1 part detergent to 10 parts of water, forming a mixture having a viscosity ranging between 50 to 500 cP, at a temperature of about 20° C. and a shear rate of 4 s−1, preferably 150 to 475 cP or more preferably 50 to 350 cP, dispensing it into said machine, washing and rinsing the fabrics under condition suitable for the fabric.

### DESCRIPTION OF THE FIGURES

FIG. 1—provides the impact of anionic to non-ionic ratios on the viscosity and cloud point on the concentrated compositions according to the present invention.

FIG. 2—provides the impact of anionic to non-ionic ratios on the viscosity and cloud point on the diluted compositions according to the present invention.

FIG. 3—provides the impact of different dilutions on the viscosity profile.

FIGS. 4 and 5 provide the impact of different concentrations of polyhydric alcohol to surfactant and their respective ratios on the viscosity profile and cloud point of the composition according to the present invention.

### DETAILED DESCRIPTION OF THE INVENTION

### Definitions

The following definitions are used in the present application.

The term “about” as used in the present applicant means within a range of 2.5% of the actual recited value (i.e., having the same function or result).

The term “alkyl” refers to a straight or branched chain monovalent hydrocarbon radical having a specified number of carbon atoms. Alkyl groups may be unsubstituted or substituted with substituents that do not interfere with the specified function of the composition and may be substituted once or twice with the same or different group.

The term “alkoxy” refers to refers to a straight or branched chain monovalent hydrocarbon radical having a specified number of carbon atoms and a carbon-oxygen-carbon bond, may be unsubstituted or substituted with substituents that do not interfere with the specified function of the composition and may be substituted once or twice with the same or different group. Substituents may include methoxy, ethoxy, propoxy, t-butoxy, and the like.

The term “alkenyl” or “alkenylene” refers to a straight or branched chain divalent hydrocarbon radical having a specified number of carbon atoms and one or more non-ionic surfactants selected from the group consisting of carbon-carbon double bonds. Alkenylene groups may be unsubstituted or substituted with substituents that do not interfere with the specified function of the composition and may be substituted once or twice with the same or different group.

Examples of “alkenyl” or “alkenylene” include, but are not limited to, ethene-1,2-diyl, propene-1,3-diyl, and the like.

The term “aryl” refers to monovalent unsaturated aromatic carbocyclic radicals having a single ring, such as phenyl, or multiple condensed rings, such as naphthyl or anthryl. Aryl groups may be unsubstituted or substituted with those substituents that do not interfere with the specified function of the composition. Aryl may be substituted by halo, C₁-C₆ alkyl, C₁-C₆ alkoxy, C₂-C₆ alkenyl, substituted C₁-C₆ alkyl, C₁-C₆ substituted alkoxy, substituted C₂-C₆ alkenyl, substituted alkoxy.

“Cleaning fabrics” as used in the present application means treatment or washing of clothes or a garment to eliminate dirt and grime, eliminate unwanted pilling and loosed threads and/or to remove stains.

The terms “comprise” “comprising”, “include” and “including” when used in reference to a list of materials refer to but are not limited to the materials so listed.

As used herein, “consisting essentially of” refers to the combination of ingredients listed in the claim and excludes addition of any active ingredients to the combination. It also excludes addition of any excipient that materially affect the basic and novel properties of the composition.

The term “cycloalkyl” refers to an alicyclic hydrocarbon group having a specified number of carbon atoms. Cycloalkyl groups include those with one to twelve carbon atoms. Cycloalkyl groups may be saturated or unsaturated, unsubstituted or substituted with those substituents that do not interfere with the specified function of the composition.

The term “heterocyclic” or “heterocyclyl” refers to a monovalent three to twelve-membered non-aromatic ring containing one or more non-ionic surfactants selected from the group consisting of heteroatomic substitutions independently selected from S, O, or N and having zero to five degrees of unsaturation. Heterocyclyl groups may be unsubstituted or substituted with those substituents that do not interfere with the specified function of the composition.

The term “halo” and “halogen” refer to chloro, bromo, fluoro, and iodo.

The term “Laundry” refers to items or articles that are cleaned in a laundry washing machine. In general, laundry refers to any item or article made from or including textile materials, woven fabrics, non-woven fabrics, and knitted fabrics. The textile materials can include natural or synthetic fibers such as silk fibers, linen fibers, cotton fibers, polyester fibers, polyamide fibers such as nylon, acrylic fibers, acetate fibers, and blends thereof including cotton and polyester blends. The fibers can be treated or untreated. Exemplary treated fibers include those treated for flame retardancy. It should be understood that the term “linen” is often used to describe certain types of laundry items including bed sheets, pillow cases, towels, table linen, table cloth, bar mops and uniforms.

“Laundry composition” as used in the present application means: compositions which can be used alone for washing a Laundry and/or that can be used together with the laundry detergent during washing of the garment, and/or that can be used as a rinse cycle composition.

“Laundry detergent composition” as used in the present application means: composition used solely for the cleaning of garments and whose main action is the removal of grim and dirt, comprising a surfactant, but not having a phosphonate or a thickener.

By the term “substantially free,” is meant that the final product contains less than 0.5% weight of the identified ingredient, while by the term “free,” it is meant that the final product is free of any traces of the identified ingredient to the extent that it could be detected by general quantitative assays known in the art for detection of such ingredient in the final product or if detected, it is in residual content of the ingredient and in principle only attributable to impurities.

Any recitation of weight percent, percent by weight, % by weight, and the like are synonyms that refer to the concentration of a substance as the weight per total weight of the composition.

The recitation of numerical ranges by endpoints includes all numbers subsumed within that range (e.g. 1 to 5 includes 1, 1.5, 2, 2.75, 3, 3.80, 4, and 5).

### Compositions

The compositions according to the present invention are unique blends of anionic, non-ionic and amphoteric surfactants. In some embodiments, the unique blend further contains alkali salt to stabilize the micelles on both concentrated and diluted formulas. Accordingly, the present inventors have been able to achieve a target viscosity and stability without the use of thickeners but having isothiazolinone as a preservative and/or replacing a part of the water content with an organic solvent.

In the first aspect of the present invention, phosphonate free concentrated liquid detergent compositions are provided having a viscosity of less than 750 centipoise (cP) at temperatures ranging from 17.5 to 27.5° C., preferably in temperatures ranging between 20° C. to 25° C., which when diluted with water undergo minor changes in its viscosity. Accordingly, the first aspect of the invention provides for a phosphonate free liquid detergent composition containing (a) from about 10% to about 25%; preferably between 12% to 24%, by weight of an anionic surfactant, (b) from about 1% to about 5%, preferably between 2% to 3% by weight of an amphoteric surfactant; (c) from about 10% to about 25%; preferably between 12.5% to 23.5%, by weight of one or more non-ionic surfactants selected from the group consisting of C₁₂-C₁₆ ethoxylated non-ionic surfactants, (d) from about 10% to about 20%; preferably between 12.5% to 15%, by weight of at least one polyhydric alcohol; wherein the composition is free of any thickeners, and has a viscosity less than 750 cP, preferably between 50 to 350 cP, more preferably 100 to 250 cP at a temperature of about 20° C. and a shear rate of 4 s−1. In some embodiments, the amphoteric surfactant is present in amounts between 2.5% to 2.8% by weight of the composition.

The viscosity of the compositions according to the invention is measured at 20° C. and a shear rate of 4 s⁻¹. A device that can be used to measure the viscosity is a Brookfield DV-II-+Pro viscometer with Spindle SC4-31 at 12 rpm, which will lead to a shear rate of about 4 s⁻¹.

In some embodiments according to this aspect of the invention, the composition further includes from about 0.5 to about 7.5%, preferably between 1% to 5%, by weight of an alkali salt; and (f) up to about 45% by weight of water, preferably between 5% to 30% and most preferably between 7% to 25% by weight of water.

In some embodiments, the weight ratio of the total anionic surfactants:one or more non-ionic surfactants is 0.75-2.0:0.75-2.5 respectively, preferably 1.0-2.0:1.0-1.5, more preferably in anionic to non-ionics ratios of about 1:1; 1.5:1; 1:2 or 1:1.5.

In some embodiments, the composition according to the present invention contains an alkali salt, preferably sodium chloride.

In some embodiments, the phosphonate free liquid detergent composition of the present invention contains (a) from 12% to 24%, by weight of an anionic surfactant, (b) from 2.5% to 2.8%, by weight of an amphoteric surfactant; (c) from 12.5% to 23.5%, by weight of one or more non-ionic surfactants selected from the group consisting of C₁₂-C₁₆ ethoxylated alcohols, (d) from 12.5% to 15%, by weight of at least one polyhydric alcohol; (e) from 1% to 5%, by weight of an alkali salt; and (f) 7% to 25% by weight of water, wherein the composition is free of any thickeners, and has a viscosity ranging between 50 to 350 cP, preferably 100 to 250 cP at a temperature of about 20° C. and a shear rate of 4 s⁻¹, and wherein the weight ratio of the total anionic surfactant:one or more non-ionic surfactants is 0.75-2.0:0.75-2.5.

In other embodiments, the composition according to the present invention contains (a) sulphonic acid in amounts of about 16% to about 22% by weight; (b) cocamidopropyl betaine in amounts of about 2% to about 3%, preferably from 2.5% to 2.8%; (c) a C₁₃-C₁₅ fatty alcohols having 7EO in amounts of about 16% to about 22% by weight; (d) monopropylenglycol in amounts of about 12.5% to 15%, by weight; and (e) sodium chloride in amounts of about 2% to 3% by weight, wherein the composition is free of any thickeners, and has a viscosity ranging between 50 to 350 cP, preferably 100 to 250 cP at a temperature of about 20° C. and a shear rate of 4 s⁻¹, and wherein the weight ratio of the total anionic surfactant:one or more non-ionic surfactants is 0.75-2.0:0.75-2.5.

In another aspect, the concentrated detergent composition of the present invention is further diluted with a second volume of water characterized in that the resulting mixture has the ratio of concentrated detergent composition to water ranging between 1 to 5 part(s) detergent to up to 10 to 15 parts of water, wherein the mixture having a viscosity ranging between 100 to 500 cP, at a temperature of about 20° C. and a shear rate of 4 s⁻¹, preferably about 75 to about 475 cP, more preferably about 50 to about 350 cP and most preferably about 100 to about 250 cP, and further wherein the viscosity may increase despite dilution in the water.

### Surfactants

Surfactants are necessary for stain and soil removal. The presently described concentrated detergent composition contains a blend of anionic, non-ionic and amphoteric surfactant to maximize the efficacy of washing Laundry,

The composition can comprise any conventional anionic surfactant or any mixture of anionic surfactants. Particular anionic surfactant suitable used for the concentrated detergent composition of the present invention include, without limitation, a sulfonic acid, an alkali metal salt of C₁₀-C₁₆ alkyl benzene sulfonic acids, and preferably an alkali metal salt of linear C₁₀-C₁₃ alkyl benzene sulfonic acids. In some embodiments, the suitable anionic is a linear C₁₀-C₁₃ alkyl benzene sulfonic acids (LAS). Other suitable anionic surfactants include alkylbenzene sulfonates; alkyl ether sulfates; alkyl sulfates; alkyl and alkenyl ester sulfonates; alkyl and alkenyl sulfonates; isethionates; taurates; or mixtures thereof. Examples of alkyl ether sulfate salts include magnesium alkyl ether sulfate; sodium alkyl ether sulfate; triethanolamine alkyl ether sulfate; alkanolamine alkyl ether sulfate; and mixtures thereof. Examples of an alkylbenzene sulfonate include magnesium alkylbenzene sulfonate; sodium alkylbenzene sulfonate; triethanolamine alkylbenzene sulfonate; alkanolamine alkylbenzene sulfonate; and mixtures thereof. In some cases, an alkanolamine alkylbenzene sulfonate is triethanolamine alkylbenzene sulfonate. The amounts of anionic surfactants in the composition may vary from about 10% to about 25%; preferably between 12% to 24%, and most preferably between 16% to 22% by weight of the total concentrated detergent composition.

Amphoteric surfactants are surface-active compounds that simultaneously contain an anionic and a cationic hydrophilic group with its structure. Accordingly, it can change between anionic properties, isoelectric neutral stage and the cationic properties depending on the pH value. Particularly suitable amphoteric surfactants are the so-called betaines, such as the N-alkyl-N,N-dimethyl ammonium glycinates, for example cocoalkyl dimethyl ammonium glycinate, N-acylaminopropyl-N,N-dimethyl ammonium glycinates, for example cocoacylaminopropyl dimethyl ammonium glycinate, and 2-alkyl-3-carboxymethyl-3-hydroxyethyl imidazolines containing 8 to 18 carbon atoms in the alkyl or acyl group and cocoacylaminoethyl hydroxyethyl carboxymethyl glycinate. The fatty acid amide derivative known as Cocamidopropyl Betaine is particularly preferred. The amount of amphoteric surfactants in the composition may vary from about 1% to about 5%; preferably between 2% to 3%, by weight of the total concentrated detergent composition. In some embodiments, the amphoteric surfactant may be present in amounts of about 2.5% to about 2.8% by weight.

The composition comprises one or more non-ionic surfactants selected from the group consisting of C₁₂-C₁₆ ethoxylated alcohols, which preferably have six, seven or eight degrees of ethoxylation degree. It will be understood by the person skilled in the art that C₁₂-C₁₆ ethoxylated alcohols comprise, for example, C₁₂-C₁₄ ethoxylated alcohols, C₁₃-C₁₅ ethoxylated alcohols, C₁₄-C₁₆ ethoxylated alcohols, and combinations thereof. The preferred non-ionic surfactants are C₁₃-C₁₅ fatty alcohols with 7 degree of ethoxylation; in other words with 7 ethylene oxide units per mole of surfactant. The amount of non-ionic surfactants in the composition may vary from about 10% to about 25%; preferably between 12.5% to 23.5%, and most preferably between 16% to 22% by weight of the total concentrated detergent composition.

In some embodiments, the weight ratio of the total anionic surfactants to non-ionic surfactants is 0.75-2.0:0.75-2.5 respectively. In some embodiments, the weight ratio of the total anionic surfactants to non-ionic surfactants is 1.0-2.0:1.0-1.5; preferably 1:1; 1.5:1.0; 2:1; 1:2; or 1:1.5. In most preferred embodiments, the concentrated compositions has a weight ratio of anionic surfactants to non-ionic surfactants of 1:1.

### Organic Solvents

The concentrated detergent compositions of the present invention also contains an organic solvent. Suitable solvents include but are not limited to polyethylene glycols; poly-glycols; mono or polyhydric alcohols; water-miscible glycols; glycol ethers; hydrotropes; solvents of limited water solubility including without limitation benzyl alcohol; dipropylene glycol n-butyl ether; dipropylene glycol n-propyl ether; phenoxyethanol; and mixtures thereof. Particularly preferred are polyhydric (polyols) alcohols, such as C₂-C₆ polyhydric alcohols, preferably, monopropylenglycol. The among of a polyhydric alcohol is in the ranges of about 5% to about 20%, preferably between 12.5% to 15%, by weight of the concentrated composition. In some embodiments, the ratio of anionic surfactant to non-ionic surfactant to polyhydric alcohol may be in the ranges of about of 1:1: <0.8-1 respectively.

### Chelating Agent

The composition is free of any phosphonate chelating agent. Preferred chelating agents for the present invention include MGDA, GLDA, EDTA, and any salts thereof or combinations thereof.

In some embodiments, the chelating agent is MGDA. In some embodiments, the amount of chelating agent may be in the range of 0.1% to 2.0% by weight.

Optionally the chelating agent may be the alkali metal salts of aliphatic hydroxydi- or hydroxy-tricarboxylic acids. Suitable compounds include the alkali metal salts of malic, tartaric, isocitric, trihydroxyglutaric and, especially, citric acid. Sodium salts are generally preferred. An especially preferred compound of this class is sodium citrate.

### Other Ingredients

The concentrated detergent composition of the present invention can include soluble alkali, alkaline earth and divalent metal salts. Examples of such salt include soluble sodium or magnesium salts include, without limitation, sodium or magnesium chloride, sodium or magnesium sulfate, preferably sodium chloride.

Detergent enzymes of choice include amylase, a mannanase, a protease, a lipase, a cellulase, a pectin lyase, an endocellulase, an exocellulase or any combinations thereof.

The concentrated detergent composition of the present invention can optionally include one or more of a buffering agent, a detergent enzyme, a pH modifier, a fragrance, a colorant, an anti-bacterial agent, an anti-fading agent, a fluorescent whitening agent, a corrosion inhibitor, an opacifier, an oxygen bleach, a fabric softening agent, a chlorine scavenger, a dye transfer inhibitor, a malodor control agent, a suds control agent, a second chelating agent, and a dye-transfer inhibitor, and a preservative. However, the compositions according to the present invention will be free of phosphonate and a thickener.

The ratio of all these ingredients is adjusted along with the content of water so that the viscosity of the composition range between 50 to 750 centipoise (cP) at a temperature of about 20° C. and a shear rate of 4 s⁻¹, preferably between 50 to 500 (cP). For example, in some embodiment, the weight ratio of the total anionic to non-ionic ratios may be 1:1; 1.5:1; 1:2 or 1:1.5 respectively, preferably 1:1. In some embodiments the weight ratio of the total amphoteric surfactants to anionic surfactants may be 1:4-9, respectively. For example, in some embodiments, the ratio between the betaine and the anionic (LAS) may be 1:8.9; 1:6.7; 1:7.4; 1:5.9; or 1:4.4.

In some preferred embodiments, the concentrated detergent composition of the present invention contains: (a) sulphonic acid as the anionic surfactant in amounts of about 16% to about 22% by weight; (b) cocamidopropyl betaine as the amphoteric surfactant in amounts of about 2% to about 3%; (c) is a C₁₃-C₁₅ fatty alcohols having 7EO as the non-ionic surfactant in amounts of about 16% to about 22% by weight; (d) monopropylenglycol as the polyhydric alcohol is in amounts of about 12.5% to 15%, by weight; and (e) sodium chloride as the alkali salt is in amounts of about 2% to 3% by weight. In some embodiments, the composition has the viscosity ranges between 50 to 350 cP, preferably 100 to 250 cP at a temperature of about 20° C. and a shear rate of 4 s⁻¹.

Water can also be included in the compositions provided herein. The amount of water used in the composition can vary depending on the distribution of the other components of the composition. In some cases, water can be added to the composition to bring the total composition to 100% by weight. For example, a concentrated liquid detergent composition provided herein can contain from about 0 to about 45% by weight (e.g., 0%, 2%, 5%, 10%, 12%, 14%, 17%, 20%, 22%, 24%, 27%, 30%, 31%, 32%, 36%, 38%, 40%, 42%, and 45%) of water. In some cases, some or all of the water can be replaced with one or more of a monohydric alcohol, polyhydric alcohol, water-miscible solvent, or hydrotrope.

In some embodiments, when the concentrated liquid detergent composition are diluted with suitable amount of water, it undergoes minor change in viscosity, particularly less than 20% when diluted with twice amount of water. More preferably less than 10% change of viscosity is observed when the concentrated detergent composition is diluted with twice amount of volume of water.

Also provided herein is a method of cleaning fabrics in an automatic washing machine. The method can include dispensing an effective amount of a concentrated liquid laundry detergent composition, as described above, into the machine. An effective amount of the liquid composition can range from about 0.1 fluid ounces per wash load to about 2 ounces per wash load.

In yet another aspect, the present invention is directed to methods of cleaning fabrics in an automatic washing machine, said method comprising providing an effective amount of a concentrated phosphonate free liquid laundry detergent composition according to the first aspect of the present invention, with a volume of water ranging between 1 part detergent to 10 parts of water, forming a mixture having a viscosity ranging between 100 to 500 cP at 20° C. and a shear rate of 4 s⁻¹, dispensing it into said machine, washing and rinsing the fabrics under condition suitable for the fabric. In certain embodiments, the viscosity of the mixture of the laundry detergent and the water is about 150 to 475 cP at 20° C. and a shear rate of 4 s⁻¹, preferably 150 to 350 cP.

In some cases, the effective amount of the liquid composition ranges from about 0.5 fluid ounces per wash load to about 1 ounce per wash load. In certain cases, the liquid composition can disperse in water from about 15° C. to about 25° C. in less than about 5 minutes.

Unless defined otherwise, all technical and scientific terms used herein have the same meaning as is commonly understood by one of ordinary skill in the art to which this disclosure pertains.

All patents, applications, published applications, and other publications are incorporated by reference in their entirety. In the event that there is a plurality of definitions for a term herein, those in this section prevail unless stated otherwise.

The details of one or more non-ionic surfactants selected from the group consisting of embodiments of the invention are set forth in the description below. Other features, objects, and advantages of the invention will be apparent from the description, and from the claims.

### EXAMPLES

### Example 1

### Concentrated Liquid Laundry Detergent Compositions

Examples of compositions of the present invention, as phosphonate free and thickener free liquid laundry detergent compositions are set forth in Tables 1 to 3 below. The compositions were made under standard conditions by combining the respective ingredients as received from the supplier of the raw material. The amounts of material used are on a weight percent basis of the total amount of the composition. The material used are described in Table 4.

TABLE 1

| | TEST FORMULAS | | | | | | |
|---|---|---|---|---|---|---|---|
| | 1/1 | 2/2 | 3/3 | 4/4 | 5/5 | 6/6 | 7/7 |
| Ingredient's list | | | | | | | |
| Sulphonic acid 96% | 18.00 | 18.00 | 18.00 | 18.00 | 18.00 | 18.00 | 18.00 |
| Coconut fatty acids | 2.00 | 2.00 | 2.00 | 2.00 | 2.00 | 2.00 | 2.00 |
| C13-C15 fatty alcohols | 10.245 | 10.245 | 10.245 | 10.245 | 10.245 | 10.245 | 10.245 |
| 7EO | | | | | | | |
| Alkylethoxysulphate, | 12.750 | 12.750 | 12.750 | 12.750 | 12.750 | 12.750 | 12.750 |
| 2E0 @27% | | | | | | | |
| Sodium hydroxide | 4.30 | 4.30 | 4.30 | 4.30 | 4.30 | 4.30 | 4.30 |
| 48% | | | | | | | |
| Triethanolamine 99% | 2.00 | 2.00 | 2.00 | 2.00 | 2.00 | 2.00 | 2.00 |
| DTPMP C, Dequest | 2.70 | 4.70 | | | | | |
| 2066C2 | | | | | | | |
| Trilon Max Eco | | | 4.00 | 4.00 | 4.00 | 4.00 | 4.00 |
| Balanced | | | | | | | |
| NaCl 25% solution | | | | 4.00 | 8.00 | 4.00 | 8.00 |
| Betaine 30% | | | | | | 8.65 | 8.65 |
| Acticide MBS | 0.20 | 0.20 | 0.20 | 0.20 | 0.20 | 0.20 | 0.20 |
| Water | 47.805 | 45.805 | 46.505 | 42.505 | 38.505 | 33.855 | 29.855 |
| QS | 100.00 | 100.00 | 100.00 | 100.00 | 100.00 | 100.00 | 100.00 |
| pH | 8.70 | 8.70 | 8.70 | 8.70 | 8.70 | 8.70 | 8.70 |
| Cloud point | transparent | transparent | transparent | cloudy RT | cloudy RT | cloudy RT | cloudy RT |
| | RT | RT | RT | | | | |
| Viscosity at 12 rpm | — | — | — | mild paste | paste | paste | paste |
| spindle SC4-31 @ 20° C. | | | | | | | |
| (cP) | | | | | | | |
| Diluted, Test | | | | | | | |
| Formula/Water | | | | | | | |
| Test Formula | 33.40 | 33.40 | 33.40 | 33.40 | 33.40 | 33.40 | 33.40 |
| Water | 66.60 | 66.60 | 66.60 | 66.60 | 66.60 | 66.60 | 66.60 |
| QS | 100.00 | 100.00 | 100.00 | 100.00 | 100.00 | 100.00 | 100.00 |
| pH | 8.40 | 8.40 | 8.40 | 8.30 | 8.30 | 8.30 | 8.30 |
| Cloud point | cloudy rt | cloudy rt | transparent | phase | phase | phase | phase |
| | | | | separation | separation | separation | separation |
| | | | | after 2 days | after 2 days | after 2 days | after 2 days |
| Viscosity at 12 rpm | <−100 | <−100 | <−100 | 35 | 110 | 345 | 685 |
| spindle SC4-31 @ 20° C. | | | | | | | |
| (cP) | | | | | | | |
| Visual appearance | precipitate | precipitate | no precipitate | | | | |
| | after 2 hours | after 2 hours | | | | | |

TABLE 2

| | TEST FORMULAS | | | | | | |
|---|---|---|---|---|---|---|---|
| | 8/8 | 9/9 | 10/10 | 11/11 | 12/12 | 13/13 | 14/33 |
| Ingredient List | | | | | | | |
| Sulphonic acid 96% | 18.00 | 18.00 | 18.00 | 18.00 | 18.00 | 18.00 | 2200 |
| Coconut fatty acids | 2.00 | 2.00 | 2.00 | 2.00 | 2.00 | 2.00 | 2.00 |
| C13-C15 fatty alcohols | 10.245 | 10.2450 | 10.2450 | 10.2450 | 10.2450 | 10.2450 | 10.2450 |
| 7EO, | | | | | | | |
| Alkylethoxysulphate, 2E0 | 12.75 | 12.7500 | 12.7500 | 12.7500 | 12.7500 | 12.7500 | 12.750 |
| @27% | | | | | | | |
| Sodium hydroxide 48% | 4.30 | 4.30 | 4.30 | 4.30 | 4.30 | 4.30 | 5.0 |
| Triethanolamine 99% | 2.00 | 2.00 | 2.00 | 2.00 | 2.00 | 2.00 | 3.5 |
| ‘Trilon Max Eco | 4.00 | 4.00 | 4.00 | 4.00 | 4.00 | 4.00 | 4.00 |
| Balanced | | | | | | | |
| ‘Vus | 0.20 | 0.20 | 0.20 | 0.20 | 0.20 | 0.20 | 0.19 |
| NaCl 25% solution | | | | | | | 10.0 |
| Betaina 30% | | | | | | | 8.65 |
| Monopropylenglycol | | | | | | | 5.0 |
| ‘Glycerol | 20.00 | | | | | | 2.0 |
| ‘Xanthangum | 1.00 | | | | | | |
| ‘Hydroxypropyl cellulose | | 1.00 | | | | | |
| ‘Cellulon L88_liquid | | | 4.00 | | | | |
| cellulose | | | | | | | |
| Crystasense_amide | | | | 4.00 | | | |
| polymer | | | | | | | |
| ‘Polygel W30_Liquid | | | | | 4.00 | | |
| Acrylic Copolymer | | | | | | | |
| ‘Polygel W301_Liquid | | | | | | 4.00 | |
| Acrylic Copolymer | | | | | | | |
| Alpha-amylase (aep) | | | | | | | 0.555 |
| ‘Mannaway 4.0 L | | | | | | | 0.150 |
| Liq. Optical brightener | | | | | | | 0.720 |
| blend of | | | | | | | 3.00 |
| natural/synthetic oil | | | | | | | |
| and solvents | | | | | | | |
| ‘Liquitint Blue HP_water | | | | | | | 0.67 |
| solution 1% | | | | | | | |
| Water | 25.505 | 45.505 | 42.505 | 42.505 | 42.505 | 42.505 | 9.57 |
| QS | 100.00 | 100.00 | 100.00 | 100.00 | 100.00 | 100.00 | 100.00 |
| pH | 8.70 | 8.70 | 8.75 | 8.70 | 8.70 | 8.70 | 8.30 |
| Cloud point | cloudy RT | cloudy RT | slightly | slightly | slightly | slightly | Cloudy |
| | | | cloudy | cloudy | cloudy | cloudy | |
| consistency | — | — | — | — | — | — | 73′000 |
| Diluted, Test | | | | | | | |
| Formula/Water | | | | | | | |
| Test Formula | 33.40 | 33.40 | 33.40 | 33.40 | 33.40 | 33.40 | 33.40 |
| Water | 66.60 | 66.60 | 66.60 | 66.60 | 66.60 | 66.60 | 66.60 |
| QS | 100.00 | 100.00 | 100.00 | 100.00 | 100.00 | 100.00 | 100.00 |
| pH | 8.40 | 8.40 | 8.40 | 8.25 | 8.25 | 8.25 | 8.21 |
| Cloud point | Slightly | Slightly | Slightly | Slightly | Slightly | Slightly | Phase |
| | cloudy | cloudy | cloudy | cloudy | cloudy | cloudy | separation |
| | | | | | | | after 3 |
| | | | | | | | wks |
| Viscosity at 12 rpm | 30 | 30 | 15 | 25 | 25 | 25 | 280 |
| spindle SC4-31 @ 20° C. | | | | | | | |
| (cP) | | | | | | | |

TABLE 3

| | TEST FORMULAS | | | | | | | |
|---|---|---|---|---|---|---|---|---|
| | 14(44) | 15(45) | 16(48) | 17(49) | 18(50) | 19(51) | 20(52) | 21(53) |
| Ingredient list | | | | | | | | |
| Sulphonic acid 96% | 18.00 | 16.00 | 20.00 | 16.00 | 22.00 | 18.00 | 20.00 | 16.00 |
| Cocconut fatty acids | 2.70 | 2.40 | 3.00 | 2.40 | 2.00 | 2.00 | 3.00 | 2.40 |
| C12-C14 fatty | 18.00 | 16.00 | 20.00 | 16.00 | 10.2450 | 10.2450 | 20.00 | 16.00 |
| alcohols 7EO | | | | | | | | |
| Sodium hydroxide | 4.50 | 4.00 | 5.00 | 4.00 | 5.00 | 4.30 | 5.00 | 2.40 |
| 48% | | | | | | | | |
| Triethanolamine | 2.70 | 2.40 | 3.00 | 2.40 | 3.50 | 2.00 | 3.00 | 4.00 |
| 99% | | | | | | | | |
| ‘Trilon Max Eco | 4.00 | 4.00 | 4.00 | 4.00 | 4.00 | 4.00 | 4.00 | 4.00 |
| Balanced | | | | | | | | |
| ‘NaCl 25% solution | 10.00 | 10.00 | 10.00 | 10.00 | 10.00 | 10.00 | 10.00 | 10.00 |
| ‘Betaina 30% | 8.6500 | 8.6500 | 8.6500 | 8.6500 | 8.6500 | 8.6500 | 8.6500 | 8.6500 |
| VUS | 0.1900 | 0.1900 | 0.1900 | 0.1900 | 0.1900 | 0.1900 | 0.1900 | 0.1900 |
| Monopropylenglycol_{—} | 12.60 | 11.20 | 14.00 | 14.00 | 14.00 | 14.00 | 14.00 | 14.00 |
| Amplify prime 100 L | | | | | | | 0.5550 | 0.5550 |
| Mannaway 4.0 | | | | | | | 0.1500 | 0.1500 |
| Liq Optical brightener | | | | | | | 0.7200 | 0.7200 |
| New Addition (CFF) | | | | | | | 3.0000 | 3.0000 |
| Liquitint Blue HP | | | | | | | 0.6700 | 0.6700 |
| water sol'n 1% | | | | | | | | |
| water | 18.6600 | 25.1600 | 12.1600 | 22.3600 | 20.4150 | 26.6150 | 7.0650 | 17.2650 |
| QS | 100.00 | 100.00 | 100.00 | 100.00 | 100.00 | 100.00 | 100.00 | 100.000 |
| pH | 8.30 | 8.30 | 8.30 | 8.30 | 8.38 | 8.30 | 8.35 | 8.36 |
| Appearance, cloud | +15 | +15 | <−3 | −1 | +5 | +8 | <−3 | <−3 |
| point | | | | | | | | |
| viscosity | 175 | 170 | 180 | 140 | 145 | 125 | 160 | 155 |
| Diluted Test | | | | | | | | |
| Formula/water | | | | | | | | |
| Test Formula | 33.40 | 33.40 | 33.40 | 33.400 | 33.40 | 33.40 | 33.40 | 33.40 |
| Water | 66.60 | 66.60 | 66.60 | 66.60 | 66.60 | 66.60 | 66.60 | 66.60 |
| QS | 100.00 | 100.00 | 100.00 | 100.00 | 100.00 | 100.00 | 100.00 | 100.00 |
| pH | 8.20 | 8.20 | 8.20 | 8.20 | 8.24 | 8.20 | 8.20 | 8.22 |
| Appearance cloud | good | good | <−3 | <−3 | good | good | <−3 | <−3 |
| point | RT | RT | | | RT | RT | | |
| Viscosity at 12 rpm | 410 | 365 | 340 | 315 | 290 | 290 | 270 | 225 |
| spindle SC4-31 @ | | | | | | | | |
| 20° C. (cP) | | | | | | | | |

TABLE 4

| RAW MATERIAL (Manufacturer) | CHEMICAL NAME (Function) |
|---|---|
| Sulphonic acid 96% (SASOL) | benzenesulfonic acid, 4-C10-13-sec-alkyl derivs. (anionic surfactant) |
| Cocconut fatty acids (WILMAR) | fatty acids, C12-18 and C18-unsatd (anionic surfactant) |
| C13-C15 fatty alcohols 7EO, (SASOL) | alcohols, C12-13-branched and linear, ethoxylated (non-ionic |
| | surfactant) |
| C12-C14 fatty alcohols 7EO, (KOLB, SASOL) | alcohols, C12-14 ethoxylated (non-ionic surfactant) |
| C12-C14 fatty alcohols 6EO, (KOLB) | alcohols, C12-14 ethoxylated (non-ionic surfactant) |
| C12-C14 fatty alcohols 5EO, (KOLB) | alcohols, C12-14 ethoxylated (non-ionic surfactant) |
| Alkylethoxysulphate, 2E0 @27% (SASOL) | Alcohols, C12-14, ethoxylated, sulfates, sodium salts (anionic |
| | surfactant) |
| Alkylethoxysulphate, 2E0 @70% (SASOL) | Alcohols, C12-14, ethoxylated, sulfates, sodium salts (anionic |
| | surfactant) |
| Sodium hydroxide 48% (INEOS) | sodium hydroxide (inorganic base) |
| Triethanolamine 99% (BASF, BRENNTAG) | 2,2′,2″-nitrilotriethanol (organic amine) |
| Monoethanolamine 99% (INEOS) | 2-aminoethanol (organic amine) |
| DTPMP C, Dequest 2066C2 (ITALMATCH) | Diethylenetriaminepenta(methylenephosphonicacid) sodium salt |
| | (complexing agent) |
| Trilon Max Eco Balanced (BASF) | Alanine, N,N-bis(carboxymethyl)-, trisodium salt (complexing |
| | agent) |
| Citric acid monohydrated 50%, | 2-hydroxy 1,2,3 propane-tricarboxylic acid (organic acid) |
| (JUNGBUNZLAUER AUSTRIA) | |
| NaCl 25% solution (TRISAL) | sodium chloride (inorganic salt) |
| Betaina 30% (ZSCHIMMER & SCHWARZ) | 1-Propanaminium, 3-amino-N-(carboxymethyl)-N,N-dimethyl-, N- |
| | (C8-18 and C18-unsatd. acyl) derivs., inner salts (amphoteric |
| | surfactant) |
| Acticide MBS (THOR) | 2-methyl-2H-isothiazol-3-one + 1,2-benzisothiazol-3(2H)-one |
| | (preservative) |
| BIT 20%, (THOR) | 1,2-benzisothiazol-3(2H)-one (preservative) |
| Sodium sulphite (UNICHIMICA) | sodium sulfite (inorganic salt) |
| Monopropylenglycol_(DOW, BRENNTAG) | Propane-1,2-diol (Solvent) |
| Glycerol (TEMIX OLEO) | Glycerol, Propane-1,2,3-triol (solvent) |
| Sodium cumen sulphonate | Benzenesulfonic acid (1-methylethyl), sodium salt (hydrotrop) |
| 40%_(BRENNTAG) | |
| Xanthangum (JUNGBUNZLAUER AUSTRIA) | Xanthan gam, (Rheology Modifier) |
| Hydroxypropyl cellulose | Hydroxypropyl cellulose, (Rheology Modifier) |
| Cellulon L88_liquid cellulose(CPKELKO) | sodium carboxymethyl cellulose, (Rheology Modifier) |
| Polygel W30_Liquid Acrylic Copolymer | Acrylates Palmeth 25/Itaconate Copolymer, (Rheology Modifier) |
| (3V SIGMA) | |
| Amplify Prime 100 L (NOVOZYME) | Alpha-amylase (aep), (enzyme) |
| Mannaway 4.0 L (NOVOZYME) | Mannanase (Mannanendo-1,4-beta-mannosidase) (aep), (enzyme) |
| Liq. Optical brightnener (IGCAR) | Disodium 2,2′-([1,1′-biphenyl]-4,4′- |
| | diyldivinylene)bis(benzenesulphonate), (dye/optical brightener) |
| New Addition (CFF) | blend of natural/synthetic oil and solvents, (perfume) |
| VUS | 2-methyl-2H-isothiazol-3-one + 1,2-benzisothiazol-3(2H)-one |
| | (preservative) |
| Liquitint Blue HP_water solution 1% | 1,4-Bis{[2-(2-substituted ethoxy)ethoxy]alkylamino}-9,10- |
| (MILLIKEN) | anthracenedione, (dye) |
| water | water |

The resulting rheology and viscosity reveals that the stability and physical appearance of the compositions 18 (50), 19 (51), 20 (52) and 21 (53) are superior as to other combinations, where the anionic, amphoteric, non-ionic surfactants follow a ratio of 1:0.15:1 (about 1:0.10 to 0.15:1, when respective ingredients are at 100% purity) and the non-ionic is a C₁₂-C₁₄ fatty alcohols 7EO.

### Example 2

### Impact of Different Ratios of Anionic Surfactant to Non-Ionic on Viscosity and Cloud Point.

Compositions according to the present invention were manufactured according to the following steps. First, deionized water, mono propylene glycol, sodium hydroxide and triethanolamine were mixed in a beaker container. Then Ethoxylated alcohol C13-C15 at 7EO, the Triol M eco balance were added into the container while being stirred, followed by addition of the sulphonic acid and coconut fatty acids. The mixing continued until a homogenous solution free of any lumps was obtained. The mixture was then allowed to be cooled to reach 30° C. while Betaine and sodium chloride solution were added into the mixture. As pH continued to be maintained in the ranges of 8 to 8.5, the enzymes, optical brightener, dyes and perfumes were added until a homogenous solution was obtained. Viscosity, cloud point and pH were measured as depicted in the Table 5 below.

TABLE 5
Concentrated Products at different anionic to non-ionic ratios

| | Ratio | | | | | |
|---|---|---|---|---|---|---|
| | 1:1 | 1:1 | 2:1 | 1.5:1 | 1:2 | 1:1.5 |
| | Test # | | | | | |
| Ingredients | 1 | 2 | A | B | C | D |
| Alkyl Benzene Sulphonic Acid | 20.00 | 16.00 | 24.00 | 18.00 | 12.00 | 12.00 |
| 96% | | | | | | |
| Coconut Fatty Acid | 3.00 | 2.40 | 3.00 | 3.00 | 3.00 | 3.00 |
| C12-C14 fatty alcohol 7EO | 20.00 | 16.00 | 12.00 | 12.00 | 24.00 | 18.00 |
| Sodium Hydroxide 48% | 5.00 | 4.00 | 6.00 | 4.50 | 2.80 | 2.80 |
| Triethanolamine 99% | 3.00 | 2.40 | 3.00 | 3.00 | 3.00 | 3.00 |
| Trilon Max Eco Balanced | 4.00 | 4.00 | 4.00 | 4.00 | 4.00 | 4.00 |
| Monopropyleneglycol | 14.00 | 14.00 | 14.00 | 14.00 | 14.00 | 14.00 |
| NaCl 25% Soln | 10.0 | 10.00 | 10.00 | 10.00 | 10.00 | 10.00 |
| Betaine 30% | 8.65 | 8.65 | 8.65 | 8.65 | 8.65 | 8.65 |
| Acticide MBS | 0.19 | 0.19 | 0.19 | 0.19 | 0.19 | 0.19 |
| Amplify Prime | 0.55 | 0.56 | 0.556 | 0.56 | 0.56 | 0.56 |
| Mannaway | 0.15 | 0.15 | 0.15 | 0.15 | 0.15 | 0.15 |
| Liq. Optical brightener | 0.72 | 0.72 | 0.72 | 0.72 | 0.72 | 0.72 |
| New Addition | 3.00 | 3.00 | 3.00 | 3.00 | 3.00 | 3.00 |
| Liquitnt Blue | 0.67 | 0.67 | 0.67 | 0.67 | 0.67 | 0.67 |
| water | 7.07 | 17.27 | 10.07 | 17.57 | 13.27 | 19.27 |
| Total Vol | 100.00 | 100.00 | 100.00 | 100.00 | 100.00 | 100.00 |
| pH | 8.35 | 8.36 | 8.35 | 8.38 | 8.04 | 8.07 |
| Cloud Point ° C. | <−3 | <−3 | −1 | <−3 | <−3 | <−3 |
| Viscosity at 12 rpm spindle | 160 | 155 | 135 | 100 | 150 | 120 |
| SC4-31 @ 20° C. (cP) | | | | | | |

The compositions of Table 5 were then diluted with sufficient amount of water to measure the impact on viscosity and cloud point.

TABLE 6
Diluted Product

| Test | 1D | 2D | AD | BD | CD | DD |
|---|---|---|---|---|---|---|
| Concentrated soln | 34.00 | 34.00 | 34.00 | 34.00 | 34.00 | 34.00 |
| Water | 66.00 | 66.00 | 66.00 | 66.00 | 66.00 | 66.00 |
| | 100.00 | 100.00 | 100.00 | 100.00 | 100.00 | 100.00 |
| pH | 8.20 | 8.22 | 8.26 | 8.29 | 8.00 | 8.00 |
| Cloud point ° C. | <−3 | <−3 | +2 | <−3 | <−3 | <−3 |
| Viscosity at 12 rpm | 270 | 225 | 190 | 150 | 220 | 150 |
| spindle SC4-31 @ 20° C. | | | | | | |
| (cP) | | | | | | |

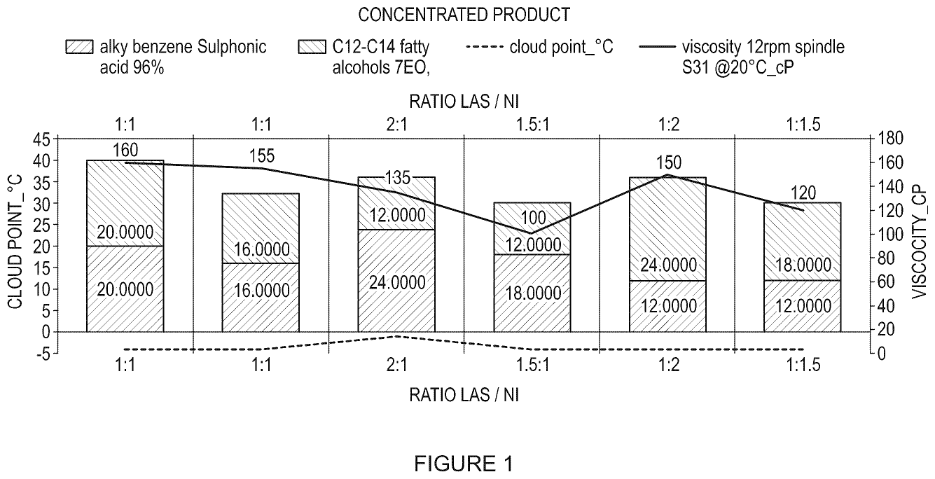

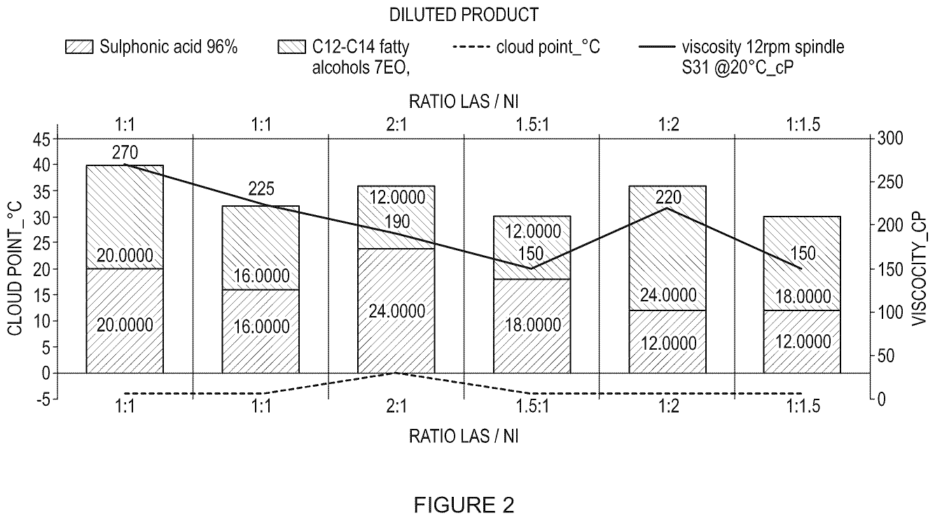

The results as shown in FIGS. 1 and 2 indicate that the ratios of 1:1 anionic to non-ionic surfactant provided superior homogenous solutions as compared to other ratios.

### Example 3

Performance Test—Evaluation of the Viscosity Profile with Different Dilution Ratio

Two concentrated liquid laundry detergent compositions according to the present invention were prepared by combining the ingredients set forth in Table 7, as liquid laundry (LL) LL 20:20 and LL 16:16. Initially water, monopropyleneglycol, sodium hydroxide and triethnolamine were combined. The combination was stirred and to such combination, ethoxylated alcohol C₁₃-C₁₅+7EO and Trilon M were added. While mixing until the combination became homogeneous, the quantity of sulphonic acid was added and mixed until homogenous, followed by the addition of coconut fatty acids and stirring of the same for 10 minutes. The mixing continued for additional 3 minutes till producing a lump free homogenous solution. While starting to cool the solution to reach 30 deg C., Betaine and sodium chloride solution were added to the solution. pH check revealed a pH of about 8.37. Subsequently, Acticide, Amylase, Mannase, liq. optical brightener, perfume and dye were further added while mixing the mixture until a homogenous composition was prepared. The final composition has pH of about 8.37 and a cloud point of less than 4° C.

The list of ingredients for the compositions 20:20 and 16;16 is provided in Table 7 below:

TABLE 7

| Ingredient List | 20:20 | 16:16 |
|---|---|---|
| Sulphonic acid 96% | 20 | 16 |
| COCONUT FATTY ACID (TOPPED) | 3 | 2.4 |
| C12-C14 fatty alcohols 7EO, | 20 | 16 |
| Sodium hydroxide 48% | 5 | 4 |
| Triethanolamine 99% | 3 | 2.4 |
| Trilon Max Eco Balanced | 4 | 4 |
| Monopropylenglycol | 14 | 14 |
| NaCl 25% solution (Trisal) | 10 | 10 |
| Betaina30% | 8.65 | 8.65 |
| ActicideMBS | 0.19 | 0.19 |
| Amplify Prime 100 L | 0.555 | 0.555 |
| Mannaway 4.0 L | 0.15 | 0.15 |
| Liq. Optical brightnener | 0.72 | 0.72 |
| New Addition | 3.00 | 3.00 |
| Liquitint Blue HP water solution 1% | 0.67 | 0.67 |
| water | 7.065 | 17.265 |
| QS | 100.00 | 100.00 |
| pH_5% | 8.37 | 8.38 |
| cloud point_° C. | <−4 | <−4 |
| Viscosity at 12 rpm spindle SC4-31 @ | 150 | 145 |
| 20° C. (cP) | | |

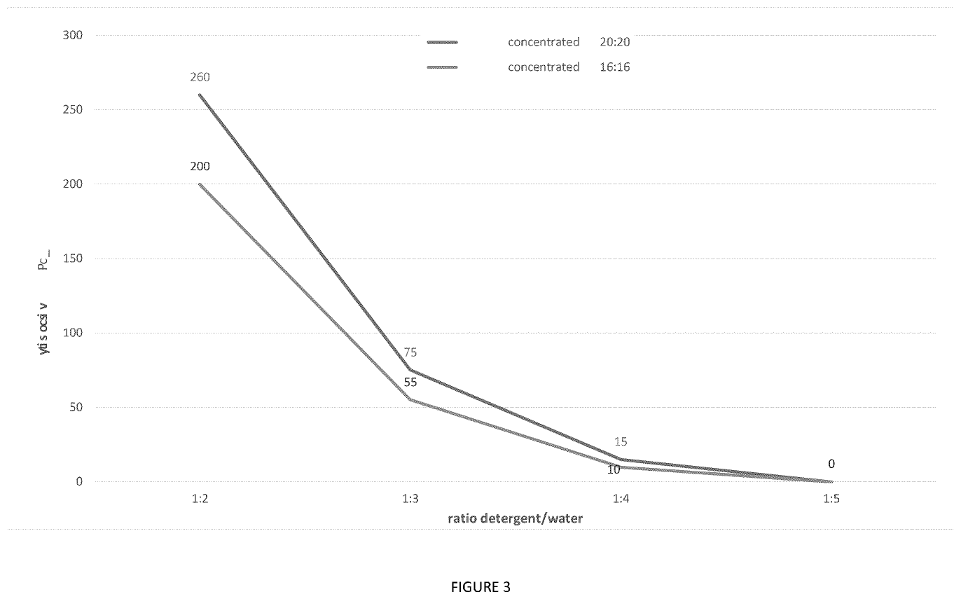

The resulting concentrated compositions were then diluted in 1:2, 1:3, 1;4 and 1:5 ratios with water and then viscosities of the resulting compositions were measured. The results are highlighted below in Tables 8 and 9 below and FIG. 3 indicates that the ratios of the surfactants rather than the actual amount of surfactants appears to impact the viscosity.

TABLE 8
20:20 DILUTED PRODUCTS

| Diluted Ratios | 1:2 | 1:3 | 1:4 | 1:5 |
|---|---|---|---|---|
| Concentrated composition | 34 | 25 | 20 | 17 |
| Water | 66 | 75 | 80 | 83 |
| Total | 100.00 | 100.00 | 100.00 | 100.00 |
| pH_5% | 8.24 | 8.21 | 8.13 | 8.12 |
| cloud point_° C. | <−4 | <−4 | <−4 | <−4 |
| Viscosity at 12 rpm spindle | 260 | 75 | 15 | 0 |
| SC4-31 @ 20° C. (cP) | | | | |

TABLE 9
16:16 DILUTED PRODUCTS

| Diluted Ratios | 1:2 | 1:3 | 1:4 | 1:5 |
|---|---|---|---|---|
| Concentrated composition | 34 | 25 | 20 | 17 |
| Water | 66 | 75 | 80 | 83 |
| Total | 100.00 | 100.00 | 100.00 | 100.00 |
| pH_5% | 8.26 | 8.18 | 8.12 | 8.09 |
| cloud point_° C. | <−4 | <−4 | <−4 | <−4 |
| Viscosity at 12 rpm spindle | 200 | 55 | 10 | 0 |
| SC4-31 @ 20° C. (cP) | | | | |

Those of ordinary skill in the art can observe that higher viscosities were obtained following the dilution with water at ratio 1:2 for the both 20:20 or 16:16 concentrated composition. More over there were no strong differences between the base and the diluted products when using different amounts of surfactant. Further dilutions followed the general trend that when % water is increased in the diluted product, the viscosity of the diluted product will decrease.

### Example 4

Performance Test-Evaluation of the Viscosity Profile with Different Amounts of Polyhydric Alcohols

To determine the preferred amounts of polyhydric alcohol in the concentrated composition, concentrated liquid laundry detergents according to the present invention were prepared by combining the ingredients set forth in Table 10 following the same process as Example 4.

TABLE 10
20:20- (concentrated base)

| Ingredients | Concentration |
|---|---|
| Sulphonic acid 96% | 20.0 |
| COCONUT FATTY ACID (TOPPED) | 3.00 |
| C12-C14 fatty alcohols 7EO, | 20.00 |
| Sodium hydroxide 48% | 5.00 |
| Triethanolamine 99% | 3.00 |
| Trilon Max Eco Balanced | 4.00 |
| Monopropylenglycol | See Table 11 |
| NaCl 25% solution (Trisal) | 10.00 |
| Betaina 30% | 8.65 |
| Acticide MBS | 0.19 |
| Amplify Prime 100 L | 0.55 |
| Mannaway 4.0 L | 0.15 |
| Liq. Optical brightener | 0.72 |
| New Addition | 3.00 |
| Liquitint Blue HP_water solution 1% | 0.67 |
| water | 7.065 |
| | 86 |

Physical appearance and consistencies of the formulas A to G varied significantly. Formula A was a gel paste so viscous that it appeared a solid mixture. Formula B was also a very viscous and paste like composition. Both formulas D and E showed phase separation after 1 day.

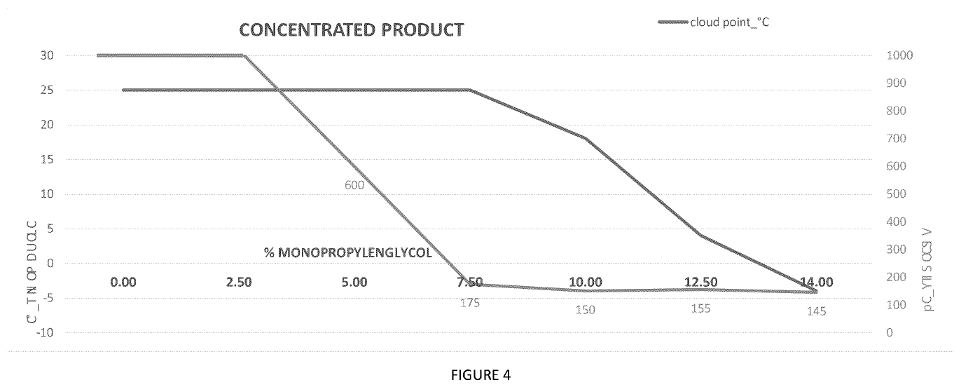

However, formulas F and G seemed to provide the best physical attributes and viscosity among all variations (FIG. 4).

TABLE 11

| TEST | A | B | C | D | E | F | G |
|---|---|---|---|---|---|---|---|
| 20:20 concentrated | 86.00 | 86.00 | 86.00 | 86.00 | 86.00 | 86.00 | 86.00 |
| base | | | | | | | |
| Monopropylene glycol | 0.0 | 2.5 | 5.0 | 7.5 | 10.0 | 12.5 | 14.0 |
| water | 14.000 | 11.5 | 9.0 | 6.5 | 4.0 | 1.500 | 0.000 |
| | 100.000 | 100.0 | 100.0 | 100.0 | 100.0 | 100.0 | 100.0 |
| | | | | separated | separated | | |
| pH_5% | 8.47 | 8.47 | 8.47 | 8.47 | 8.47 | 8.47 | 8.47 |
| cloud point_° C. | 25 | 25 | 25 | 25 | 20 | −1 | <−4 |
| Viscosity at 12 rpm | <100′000 | <100′000 | <100′000 | 200 | 160 | 150 | 150 |
| spindle SC4-31 @ | | | | | | | |
| 20° C. (cP) | | | | | | | |

Each of the formulas in the Table 11 were subsequently diluted with water according to Table 12 below:

TABLE 12
Diluted product at ratios of 1:2 (base to water)

| TEST | AD | BD | CD | DD | ED | FD | GD |
|---|---|---|---|---|---|---|---|
| 20:20- concentrated | 34.00 | 34.00 | 34.00 | 34.00 | 34.00 | 34.00 | 34.00 |
| base | | | | | | | |
| Tap water_28° F. | 66.00 | 66.00 | 66.00 | 66.00 | 66.00 | 66.00 | 66.00 |
| | 100.00 | 100.00 | 100.00 | 100.00 | 100.00 | 100.00 | 100.00 |
| pH_5% | 8.35 | 8.35 | 8.35 | 8.35 | 8.35 | 8.35 | 8.35 |
| cloud point_° C. | <−4 | <−4 | <−4 | <−4 | <−4 | <−4 | <−4 |
| Viscosity at 12 rpm | 410 | 370 | 340 | 320 | 290 | 280 | 270 |
| spindle SC4-31 @ | | | | | | | |
| 20° C. (cP) | | | | | | | |

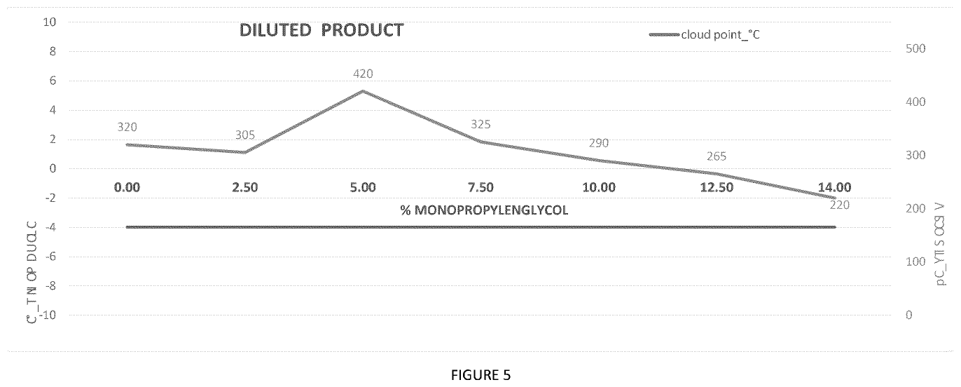

Diluted formulas F and G provided the confirmation that the minimum amount of MPG was 12.5% to ensure a good viscosity and to avoid phase separation of the product during its manufacturing process (FIG. 5). Accordingly a ratio of 1:1: <0.8 for anionic surfactant to non-ionic surfactant to polyhydric alcohol appears to provide the best physical properties for the detergent compositions of the present invention.

### Other Embodiments

It is to be understood that while the invention has been described in conjunction with the detailed description thereof, the foregoing description is intended to illustrate and not limit the scope of the invention, which is defined by the scope of the appended claims. Other aspects, advantages, and modifications are within the scope of the following claims.

1. A phosphonate free concentrated liquid laundry detergent composition comprising
(a) from about 10% to about 25% by weight of an anionic surfactant;
(b) from about 1% to about 5% by weight of an amphoteric surfactant;
(c) from about 10% to about 25% by weight of one or more non-ionic surfactants selected from the group consisting of C₁₂-C₁₆ ethoxylated alcohols;
(d) from about 10% to about 20% by weight of at least one polyhydric alcohol;
wherein the composition is free of any thickeners and has a viscosity less than 750 cP at a temperature of about 20° C. and a shear rate of 4 s⁻¹, and wherein the weight ratio of the total anionic surfactant:one or more non-ionic surfactants is 0.75-2.0:0.75-2.5.

2. The composition of claim 1, further comprising
(e) from about 0.5 to about 7.5% by weight of an alkali salt; and
(f) up to about 45% by weight of water.

3. The composition according to claim 1, wherein:
the anionic surfactant is selected from the group consisting of alcohol sulfates and sulfonates, alcohol phosphates and phosphonates, alkyl benzene sulfonic acids, alkyl ester sulfates, alkyl diphenyl ether sulfonates, alkyl sulfates, alkyl ether sulfates, sulfate esters of an alkylphenoxy polyoxyethylene ethanol, alkyl monoglyceride sulfates, alkyl sulfonates, alkyl ether sulfates, alpha-olefin sulfonates, beta-alkoxy alkane sulfonates, alkyl ether sulfonates, ethoxylated alkyl sulfonates, alkylaryl sulfonates, alkylaryl sulfates, alkyl monoglyceride sulfonates, alkyl carboxylates, alkyl ether carboxylates, alkyl alkoxy carboxylates, sulfosuccinates, acyl glycerol sulfonates, fatty oleyl glycerol sulfates, alkyl phenol ethylene oxide ether sulfates, paraffin sulfonates, alkyl phosphates, isethionates, N-acyl taurates, alkyl succinamates and sulfosuccinates, alkylpolysaccharide sulfates, alkylpolyglucoside sulfates, alkyl polyethoxy carboxylates, and mixtures thereof;
the amphoteric surfactant is selected from the group consisting of betaines, imidazolines, proprionates and mixtures thereof;
the one or more non-ionic surfactants selected from the group consisting of C₁₂-C₁₆ ethoxylated alcohols are selected from the group consisting of C₁₂-C₁₆ ethoxylated alcohols having six, seven or eight degrees of ethoxylation degree; and
the polyhydric alcohol is selected from the group consisting of C₂-C₆ alcohols, containing from 2-6 hydroxyl group or any combinations thereof.

4. The composition of claim 1, wherein the weight ratio of the total anionic surfactant(s) to non-ionic surfactant(s) is 1.0-2.0:1.0-1.5.

5. The composition of claim 1, wherein the weight ratio of the total anionic surfactant(s):non-ionic surfactant(s) is 1:1, 1:0.5, 1.5:1.0, 1:2, or 1:1.5.

6. The composition of claim 1, wherein the ratio of anionic surfactant to amphoteric surfactant is in the ranges from 5-10:0.5-1.5.

7. The composition of claim 1, wherein the weight of the anionic surfactant is in the range of 16% to 22% and the weight of the non-ionic surfactant ranges between about 16% to 22%.

8. The composition of claim 1, further comprising a chelating agent selected from the group consisting of MGDA, GLDA, EDTA, and any salts thereof or combinations thereof.

9. The composition of claim 1, further comprising an enzyme selected from the group consisting of an amylase, a mannanase, a protease, a lipase, a cellulase, a pectin lyase, an endocellulase, an exocellulase or any combinations thereof.

10. The composition of claim 2, wherein the alkali salt is sodium chloride.

11. The composition of claim 1, wherein the viscosity ranges between 50 to 350 cP at a temperature of about 20° C. and a shear rate of 4 s⁻¹, preferably 100 to 250 cP.

12. The composition of claim 1, wherein the pH of the composition ranges between 7 to about 8.75, preferably between 8.2 to 8.6.

13. The composition of claim 2, wherein:
a) the anionic surfactant is sulphonic acid in amounts of about 16% to about 22% by weight;
(b) the amphoteric surfactant is cocamidopropyl betaine in amounts of about 2% to about 3%;
(c) the one or more non-ionic surfactants selected from the group consisting of C₁₂-C₁₆ ethoxylated non-ionic surfactant is a C₁₃-C₁₅ fatty alcohol having 7EO in amounts of about 16% to about 22% by weight;
(d) the polyhydric alcohol is monopropylenglycol in amounts of about 12.5% to 15%, by weight; and
(e) the alkali salt is sodium chloride in amounts of about 2% to 3% by weight.

14. A method of cleaning fabrics in an automatic washing machine, said method comprising providing an effective amount of a concentrated phosphonate free liquid laundry detergent composition according to claim 1, with a volume of water, wherein the amount of water is determined based on a dilution ratio of 1 part detergent to 10 parts of water, forming a mixture having a viscosity ranging between 100 to 750 cP, at a temperature of about 20° C. and a shear rate of 4 s⁻¹, dispensing it into said machine, washing and rinsing the fabrics under condition suitable for the fabric.

15. The method of claim 14, wherein the viscosity of the mixture of the laundry detergent and the water is about 150 to 475 cP at a temperature of about 20° C. and a shear rate of 4 s⁻¹.

16. The composition of claim 1, wherein the composition comprises between 12% to 24% by weight of an anionic surfactant.

17. The composition of claim 1, wherein the composition comprises between 2% to 3% by weight of an amphoteric surfactant.

18. The composition of claim 1, wherein the composition comprises between 12.5% to 23.5% by weight of one or more non-ionic surfactants selected from the group consisting of C₁₂-C₁₆ ethoxylated alcohols.

19. The composition of claim 1, wherein the composition comprises between 12.5% to 15% by weight of at least one polyhydric alcohol.
